(19) United States
(12) Patent Application Publication
(10) Pub. No.: US 2007/0034750 A1
(43) Pub. Date: Feb. 15, 2007

(54) Tubing mounting clip

(75) Inventors: Mark Joseph Pierce, Bedford, NH (US); Cheryl L. Johnson, Bedford, NH (US)

Correspondence Address: KNS ASSOCIATES, INC., P.O. BOX 10158, BEDFORD, NH, 03110-0158, US

(73) Assignee: KNS ASSOCIATES, INC., Bedford, NH (US)

(21) Appl. No.: 11/161,625

(22) Filed: Aug. 10, 2005

(51) Int. Cl. F16L 3/00

(52) U.S. Cl. 248/49

(57) ABSTRACT

A mounting clip used to secure tubing used in various applications such as heating, ventilating, air conditioning, and refrigeration. The clip comprises a resilient, flexible body and an arcuate channel or plurality of arcuate channels in which the tubing is retained by a flexible lip on the channels or other retaining means such as flat tying devices. The clip may also comprise a means for mounting in more that one plane and may contain a partial cylindrical opening to allow the axial insertion of a rigid tubing. The clip may also have a groove or scored mark that would allow this additional mounting section with the partial cylindrical opening to be broken off and used separately.

### FIELD OF THE INVENTION

This invention relates to a mounting clip used to secure tubing used in various applications such as heating, ventilating, air conditioning, and refrigeration.

### BACKGROUND OF THE INVENTION

There are many applications that require tubing, for example capillary tubing used in heating, ventilating, air conditioning, and refrigeration systems and equipment, to be mounted securely and in a certain pattern. The present mounting devices available are fabricated from stamped non-ferrous metal such as copper. This restricts them to use in one mounting plane and with one size of tubing. These devices also form a curvature for the tubing to be bent smoothly through 90 degrees.

### SUMMARY OF THE INVENTION

It is therefore an object of this invention to securely fasten tubing without the use of additional ties or securing devices. It is a further intention of this invention to provide a means for mounting multiple diameters of tubing using a single device. In addition this invention will allow mounting in two different planes perpendicular to each other.

Since many installations are made at remote locations, reducing the number of different parts carried to the site is very desirable. The invention may further comprise a means for easily breaking away the perpendicular mounting means where it becomes inconvenient or in the event the device is replacing an existing mounting. A further feature may be added wherein the part removed by breaking away may also be used to secure rigid tubing, such as a sensor tube, where a bend is not required in the tubing.

The invention eliminates the requirement for a multiplicity of different devices for securing and mounting tubing of various sizes.

### BRIEF DESCRIPTION OF THE DRAWINGS

Other objects, features and advantages will occur to those skilled in the art from the following description of the preferred embodiments, and the accompanying drawings, wherein corresponding reference characters indicate corresponding members in which:

FIG. 1 is a perspective view of one embodiment of the retaining clip of the invention, in which a single diameter of tubing is held in place without additional retaining devices;

FIG. 2 is a side view of the clip of FIG. 1;

FIG. 3 is a front view of the clip of FIG. 1;

FIG. 4 is a perspective view of an alternative embodiment the retaining clip of the invention, that can accept multiple diameters of tubing that are retained in the channels by flat tying devices;

FIG. 5 is a side view of the clip of FIG. 4;

FIG. 6 is a front view of the clip of FIG. 4;

FIG. 7 is a perspective view of yet another alternative embodiment of the retaining clip of the invention, that can accept multiple diameters of tubing that are held in the channels without additional retaing devices;

FIG. 8 is a side view of the clip of FIG. 7;

FIG. 9 is a front view of the clip of FIG. 7;

### DESCRIPTION OF THE PREFERRED EMBODIMENTS OF THE INVENTION

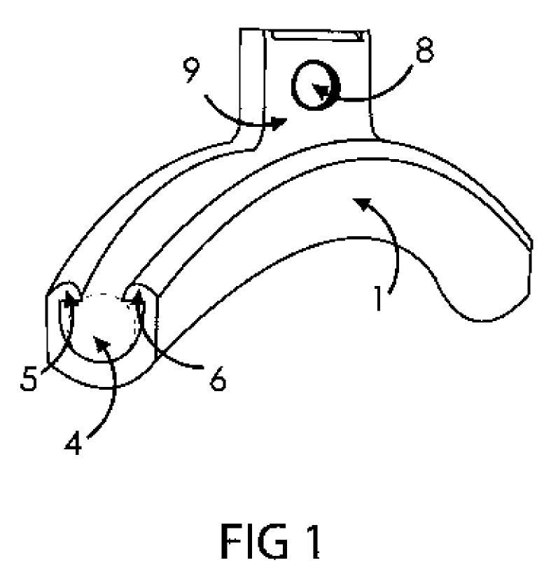

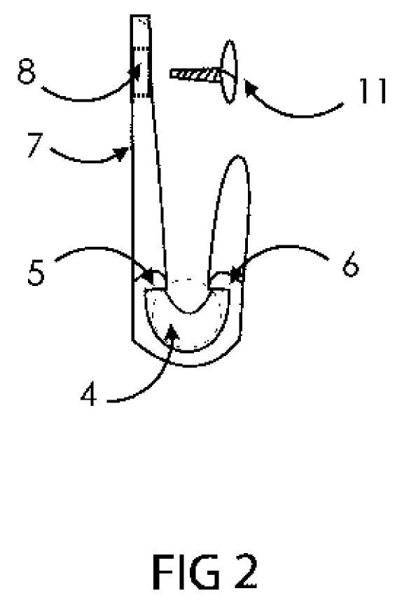

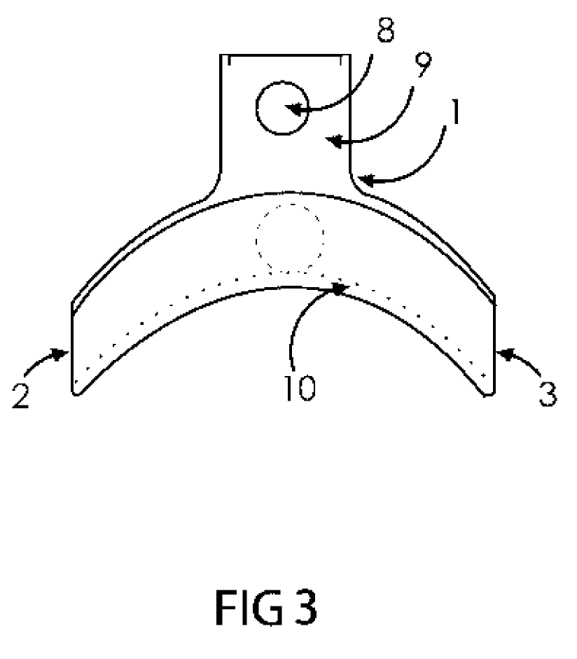

Referring now to the drawings, a preferred embodiment of the tubing mounting clip is shown in FIG. 1, FIG. 2, and FIG. 3. The tubing mounting clip is designated in its entirety by the reference numeral 1, and has a general arcuate configuration. A first end 2 is joined to a second end 3 by a curved central portion 10. The tubing is mounted in the clip by pushing it through at least one (and preferably two) “first” arms 5 and 6, and into the arcuate tube retaining area 4. The tubing being mounted is in contact with and assumes the arcuate configuration of the clip 1. The angle through which the tubing is bent by the clip is defined by tangents drawn by the ends 2 and 3 of the clip. In the embodiment shown by the drawings, the tubing is bent through an angle close to 90°. A hole 8, through which a screw 11, bolt, or other fastening device may be inserted, is included in tab 9 and whose rear surface plane 7 provides a means for mounting the retaining clip 1 to a surface whose plane is essentially parallel with the plane of the tubing. This embodiment provides for tubing that has a single outer diameter.

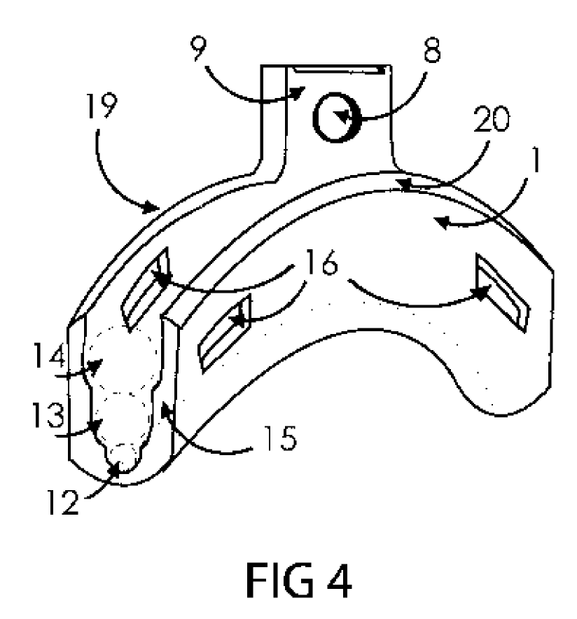

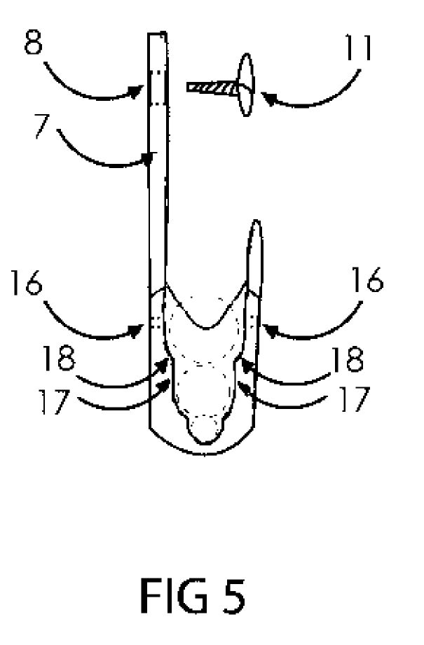

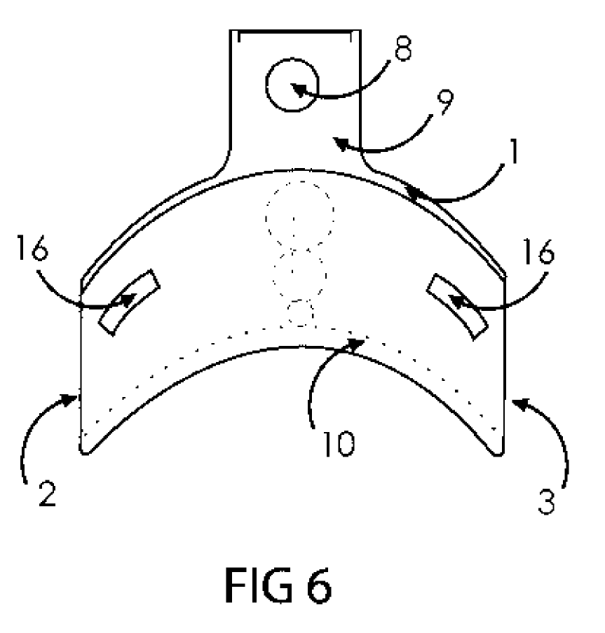

Another preferred embodiment is shown in FIG. 4, FIG. 5, and FIG. 6. In this embodiment, a plurality of “U” shaped arcuate channels are included in the body 1 instead of just one. They are arranged from the smallest diameter channel 12 to the next largest diameter channel 13 to the largest diameter channel 14. Three channels are shown, however it is obvious that it could comprise any number of channels, as long as the material is suitably rigid and the diameters are sufficiently different that the upper walls of the lower channel 17 will form an arcuate surface 18 that will support the tubing in the channel 14 above. This embodiment also comprises multiple slots 16 arranged in pairs completely piercing the channel walls 19 and 20. Flat or other conveniently shaped tying devices may be passed through these slot pairs in such a manner that they will retain the tubing in the clip.

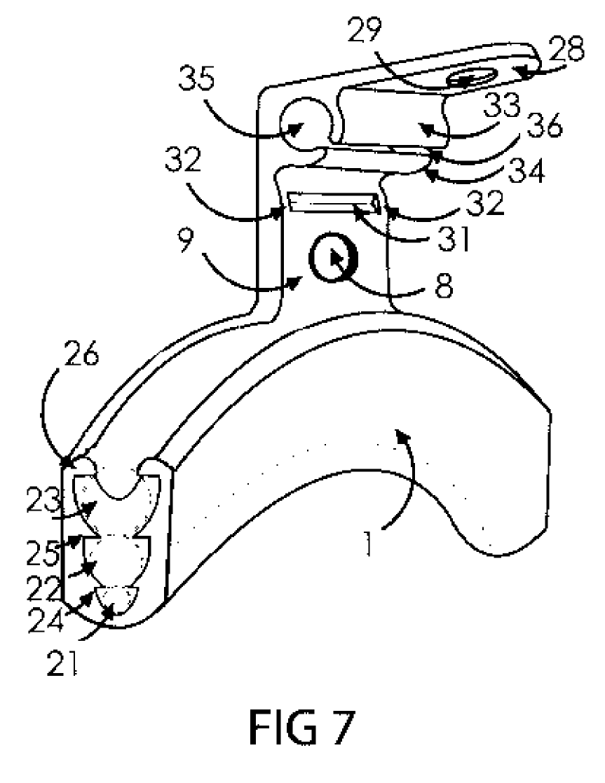

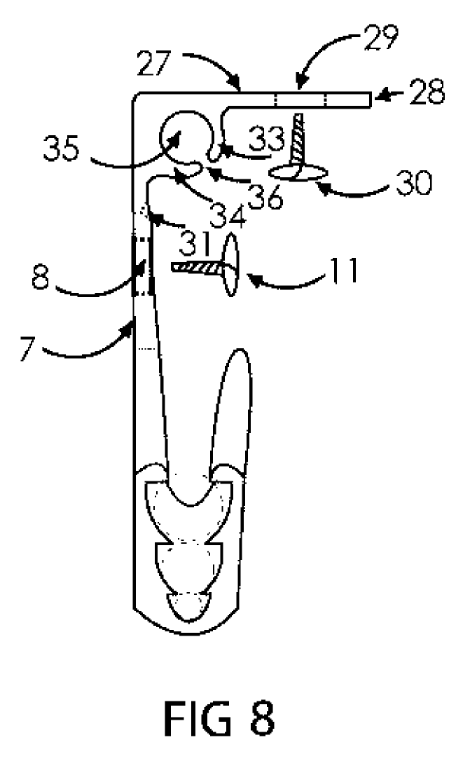

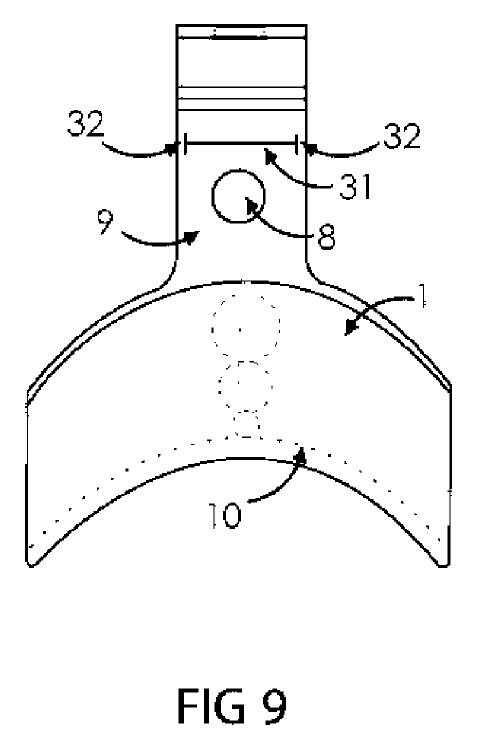

Another preferred embodiment is shown in FIG. 7, FIG. 8, and FIG. 9. This embodiment is a one-piece molded clip 1 made of plastic or other material of suitable flexibility and resilience and includes a plurality of arcuate channels 21,22, 23 of varying diameter arranged from the smallest diameter 21 at the bottom to the largest diameter 23 at the top. Each channel is partially enclosed at the top by at least one arm 24, 25, 26 and preferably 2 arms opposite each other. The tubing of a similar outer diameter is mounted in the clip by pushing it through the said arms of the channel. This embodiment also includes a second tab 28 that has a mounting surface 27 such that the mounting clip 1 can be mounted at an angle other than where the mounting plane is parallel to the plane of the tubing. The drawing shows a tab 28 for mounting to a plane that is perpendicular to the plane of the tubing, but any other angle can be implemented. A mounting hole 29, through which a screw 30, bolt, or other fastening device may be inserted, is included in tab 28. A further feature of this embodiment are two arms 33 and 34 extending from each mounting plane 7 and 27 terminating in a free end closely spaced from each other 36 forming a cylindrical opening 35. The flexible resilient material of the molded clip allows axial insertion of a rigid tubing slightly larger in diameter than the diameter of the partial opening 35 formed by the two arms 33 and 34. A further feature of this embodiment is the addition of a groove 31 that allows the tab 28 to broken off easily if it interferes with mounting of the clip in some applications. It may be necessary to leave an ungrooved or thicker region 32 at the ends of the groove 31 for additional strength.

Although specific features of the invention are shown in some drawings and not others, this is not a limitation of the invention, as the different features can be combined differently to accomplish the invention. Other embodiments will occur to those skilled in the art and are within the following claims.

What is claimed is:

1. A mounting clip for securing solid or flexible tubing, said clip integrally formed in one piece of a flexible resilient material, mounting said tubing through a preselected angle, said clip comprising an arcuate groove or channel which is equal to the outer diameter of the tubing, said channel a portion of which encircles the tubing greater than 180°, the said portion of which has sufficient flexibility to allow the tubing to enter through it without damage and retain the said tubing in firm contact with the said channel. Said clip further comprises a hole allowing the said mounting clip to be fastened to a flat surface on a plane parallel to that of the said tubing.

2. The mounting clip of claim 1 that also has a second mounting hole in a tab perpendicular or at a defined angle to the plane of the secured tubing.

3. The mounting clip of claim 2 that also has a groove or scored mark or other means to allow the said tab to be broken off at the said groove. Said groove would be placed above the first mounting hole, opposite the said arcuate groove or channel, on said plane parallel to that of said tubing.

4. The mounting clip of claim 3 that also comprises two arms extending outward from each mounting plane in proximity to the junction between the said planes. Each of said arms terminate in a free end closely spaced from each other forming a partial cylindrical opening. The flexible resilient material of the molded clip allows axial insertion of a rigid tubing slightly larger in diameter than the diameter of the partial opening formed by the two arms. Breaking the mounting clip at the said groove would create two individual mounting clips.

5. A mounting clip for securing solid or flexible tubing, said clip integrally formed in one piece for mounting said tubing through a preselected angle, said clip comprising a plurality of arcuate grooves or channels arranged from the smallest to the largest diameters which is equal to the outer diameters of the tubing to be held. The said clip also comprises slots at the outer edges arranged in such a manner to allow the passage of some retaining means such as flat tying devices. Said tying devices retaining the said tubing in the said channel. It further comprises a hole allowing the said mounting clip to be fastened to a flat surface on a plane parallel to that of the said tubing.

6. The mounting clip of claim 5 that also has a second mounting hole in a tab perpendicular or at a defined angle to the plane of the secured tubing.

7. The mounting clip of claim 6 that also has a groove or scored mark or other means to allow the said tab to be broken off at the said groove. Said groove would be placed above the first mounting hole, opposite the said arcuate grooves or channels, on said plane parallel to that of said tubing.

8. The mounting clip of claim 7 formed of a flexible resilient material that also comprises two arms extending outward from each mounting plane in proximity to the junction between the said planes. Each of said arms terminate in a free end closely spaced from each other forming a partial cylindrical opening. The flexible resilient material of the molded clip allows axial insertion of a rigid tubing slightly larger in diameter than the diameter of the partial opening formed by the two arms. Breaking the mounting clip at the said groove would create two individual mounting clips.

9. A mounting clip for securing solid or flexible tubing, said clip integrally formed in one piece of a flexible resilient material for mounting said tubing through a preselected angle, said clip comprising multiple arcuate grooves or channels, arranged from the smallest to the largest diameters which is equal to the outer diameters of the tubing to be held, said channels a portion of which encircles the tubing greater than 180°, the said portion of which has sufficient flexibility to allow the tubing to enter through it without damage and retain the said tubing in firm contact with the said channel. Said clip further comprises a hole allowing the said mounting clip to be fastened to a flat surface on a plane parallel to that of the said tubing.

10. The mounting clip of claim 9 that also has a second mounting hole in a tab perpendicular or at a defined angle to the plane of the secured tubing.

11. The mounting clip of claim 10 that also has groove or scored mark or other means to allow the said tab to be broken off at the said groove. Said groove would be placed above the first mounting hole, opposite the said arcuate grooves or channels, on said plane parallel to that of said tubing.

12. The mounting clip of claim 11 that also comprises two arms extending outward from each mounting plane in proximity to the junction between the said planes. Each of said arms terminate in a free end closely spaced from each other forming a partial cylindrical opening. The flexible resilient material of the molded clip allows axial insertion of a rigid tubing slightly larger in diameter than the diameter of the partial opening formed by the two arms. Breaking the mounting clip at the said groove would create two individual mounting clips.
